(19) United States
(12) Patent Application Publication
(10) Pub. No.: US 2008/0093879 A1
(43) Pub. Date: Apr. 24, 2008

(54) Hard Top

(75) Inventor: Michael Koch, Boeblingen (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler, Stuttgart (DE)

(21) Appl. No.: 11/884,482

(22) PCT Filed: Jan. 27, 2006
(86) PCT No.: PCT/EP06/00707

§ 371 Date: Aug. 16, 2007

(30) Foreign Application Priority Data
Feb. 19, 2005 (DE) 10 2005 007 728.5

(51) Int. Cl. B60J 7/12

(52) U.S. Cl. 296/107.08

(57) ABSTRACT

A hard top for a convertible has at least two roof parts displaceable between a closed position and a put-away position. The roof parts, in the put-away position, are put away in a trunk of the convertible and can be brought into a loading position raised in relation to the put-away position. The hard top has top kinematics with at least one top linkage, at least one driving device and at least one bearing device. The roof parts are coupled to the bearing device via at least one link of the top linkage and can be displaced by the driving device. The bearing device has a main bearing and an intermediate bearing which is movable in relation to the main bearing. A control lever is attached to a link of the top linkage in an articulated manner. The control lever is arranged between the main bearing and the intermediate bearing and is guided on a control contour which is designed in such a manner that the intermediate bearing can be moved in relation to the main bearing during the putting-away movement of the top only after the loading position has been reached.

### BACKGROUND AND SUMMARY OF THE INVENTION

This invention relates to a hard top for a convertible, with at least two roof parts which can be displaced between a closed position and a put-away position. Furthermore, the invention relates to a convertible.

A hard top of a generic type and a corresponding convertible are known from German document DE 199 60 010 C2. The top can be brought from a position in which it is put away in the trunk of the convertible into a “loading position”, as a result of which it is possible to comfortably load the trunk and to subsequently bring the roof parts into their put-away position again.

A drawback of this known solution, however, is that, because of the required deflection of the top in order to take up the loading position, an additional actuating or driving device is required, in this case a second hydraulic cylinder, which not only causes additional production and installation costs but, as an additional component, also constitutes an increased risk of failure.

It is therefore the object of the present invention to provide a hard top for a convertible in which a loading position for the roof parts can be taken up with as little outlay as possible.

According to the invention, this object is achieved by the features claimed.

During movement of the top between the closed position and the loading position, a control lever arranged, according to the invention, between the main bearing and the intermediate bearing ensures that the intermediate bearing cannot move in relation to the main bearing. In this way, only the customary folding together of the two roof parts until they reach their compact, collapsed position takes place during the putting-away movement of the top.

The control contour is designed in such a manner that, when the loading position has been reached, the intermediate bearing can move in relation to the main bearing, with the result that the entire top, which is folded in the preceding putting-away movement and is attached to the intermediate bearing via the top linkage, can be lowered and can therefore be brought out of the loading position into its put-away position. Just a reversal of the movement takes place in order to move the top from the put-away position into the loading position.

It is thereby made possible for the loading position to be taken up using just one driving device, which preferably has a respective driving element on both sides of the top, which permits simpler access to the trunk in which the hard top is preferably situated in its put-away state. As a result, it is possible to save on a second driving device, which has hitherto been required, for each side of the hard top, which also makes it possible to omit limit switches and corresponding cabling. This results in a reduction in the control outlay for moving the hard top according to the invention.

In a structurally very simple embodiment, the control contour has a recess which makes it possible for the intermediate bearing to be lowered in relation to the main bearing.

Furthermore, the control contour can be assigned to the main bearing. Although it is also possible to provide the control contour on the intermediate bearing, the assignment of the same to the main bearing has proven to be a particularly advantageous embodiment both structurally and also with regard to its function.

A convertible with a hard top according to the invention is also claimed.

Further advantageous refinements and developments of the invention are also claimed. An exemplary embodiment of the invention is illustrated schematically below with reference to the drawings.

### BRIEF DESCRIPTION OF THE DRAWINGS

FIG. 1 shows the hard top according to the invention in its closed position;

FIG. 2 shows the hard top of FIG. 1 in its loading position;

FIG. 3 shows the hard top of FIG. 1 in its put-away position;

FIG. 4 shows a view according to the arrow IV of FIG. 1;

FIG. 5 shows a first embodiment of a driving device for the hard top in the position according to FIG. 1;

FIG. 6 shows a second embodiment of a driving device for the hard top in the position according to FIG. 1; and

FIG. 7 shows a third embodiment of a driving device for the hard top in the position according to FIG. 1.

### DETAILED DESCRIPTION OF THE INVENTION

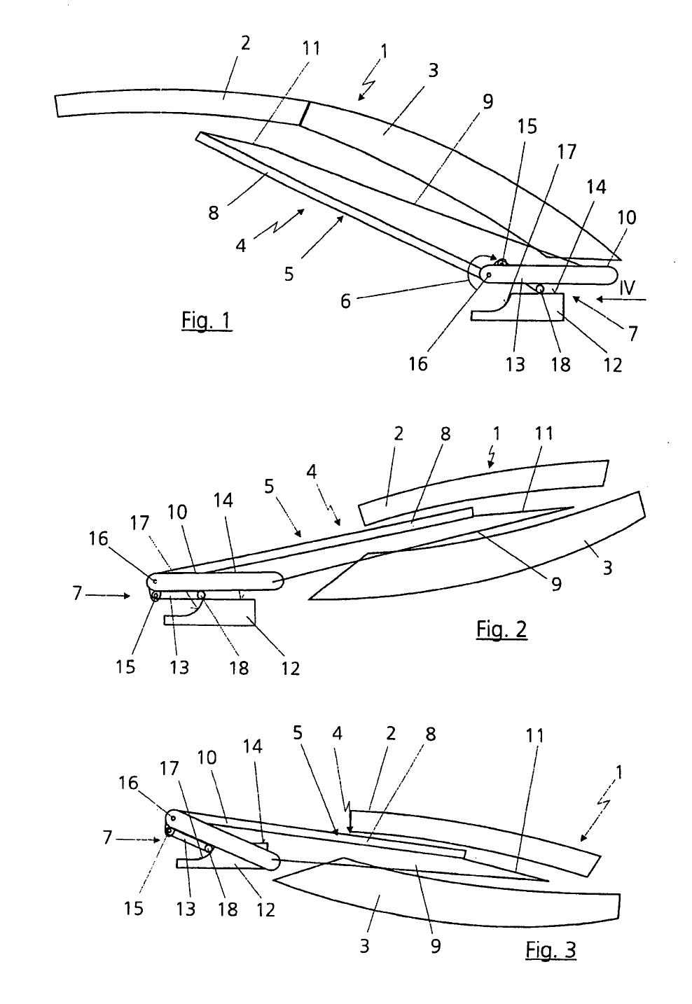

FIG. 1 shows a hard top 1 for a convertible (not illustrated in its entirety). The hard top 1 has two roof parts, namely a front roof part 2 and a rear roof part 3. In the illustration according to FIG. 1, the two roof parts 2 and 3 are in their closed position in which they form a roof for the convertible. As described below and known, for example, from German document DE 199 60 010 C2, the hard top 1 can be brought by means of a corresponding putting-away movement into a put-away position in which it is located in a trunk (not illustrated) of the convertible. This put-away position of the hard top 1 is illustrated in FIG. 3. By contrast, FIG. 2 shows a “loading position” in which the hard top 1 is raised in relation to the put-away position in order to permit better access to the trunk of the convertible. If a driver or occupant of the convertible equipped with the hard top 1 would therefore like to load the trunk, then, as described in detail below, he can bring the hard top 1 from its put-away position into the loading position, can load the trunk with any desired objects and can subsequently return the hard top 1 from the loading position into the put-away position again.

In order to move the hard top 1 between the positions illustrated in FIGS. 1 to 3, use is made of top kinematics 4, which has a top linkage 5, a driving device 6 (merely indicated by means of an arrow and described in more detail further on), and a bearing device 7. In the present case, the top linkage 5 is designed in a manner known per se as a four-bar linkage and comprises a main link 8, a C-pillar link 9, an intermediate bearing 10 and an upper connecting link 11 which connects the main link 8 to the C-pillar link 9 and is rotatable in relation to both of said links. The main link 8 and the C-pillar link 9 are each connected to the intermediate bearing 10 in an articulated manner and are therefore bound to the same with regard to their movement. In a manner which is likewise known per se but cannot be seen in FIGS. 1 to 3, the front roof part 2 is attached to the upper connecting link 11 and the rear roof part 3 is attached to the C-pillar link 9. In addition to the intermediate bearing 10 which forms part of the four-bar linkage, the bearing device 7 has a main bearing 12 which is fitted on the convertible bodywork (not illustrated). In order to ensure reliable operation of the hard top 1 and to ensure uniform distribution of forces over the same, two top linkages 5, driving devices 6 and bearing devices 7, which are arranged on either side of the hard top 1, are provided in each case in a manner which is known per se but, for clarity reasons, is not illustrated.

A control lever 13 is attached to one of the links of the top linkage 5, in the present case to the main link 8, in an articulated manner and is guided between the main bearing 12 and the intermediate bearing 10 on a control contour 14 assigned to the main bearing 12. The control lever 13 is attached to the main link 8 in an articulated manner at a pivot point 15. The pivot point 15 is at a distance from a pivot point 16 at which the main link 8 is attached to the intermediate bearing 10 in an articulated manner, thus resulting in a lever effect for the control lever 13. In a first section, on which the control lever 13 is in the position illustrated in FIG. 1, the control contour 14 runs essentially rectilinearly, and therefore the intermediate bearing 10 is always guided parallel to the main bearing 12 and cannot move in relation to the same. It is thus ensured, as is revealed from a comparison of FIGS. 1 and 2, that, during the putting-away movement of the hard top 1, only the two roof parts 2 and 3, which are attached to the intermediate bearing 10 via the top linkage 5, are moved into the trunk in the customary manner described, for example, in German document DE 199 60 010 C2.

However, as soon as the hard top 1 reaches the loading position illustrated in FIG. 2, the control lever 13 passes to a point on the control lever 14 at which the rectilinear section merges into a recess 17 which causes the control lever 13 to drop downward during the further movement of the hard top 1 and therefore permits the intermediate bearing 10 to be lowered in relation to the main bearing 12. This lowered state of the intermediate bearing 10, which corresponds to the completely put-away position of the roof parts 2 and 3, is illustrated in FIG. 3. Instead of the main bearing 12, the control contour 14 could also optionally be assigned to the intermediate bearing 10, in which case said control contour would then likewise have to be designed in such a manner that it permits the intermediate bearing 10 to move in relation to the main bearing 12 only after the loading position has been reached. This would also be possible, by means of a corresponding recess, if the control contour 14 were provided on the intermediate bearing 10.

The closing movement of the hard top 1, i.e. the transfer of the same from the position in which it is put away in the trunk into the closed position, takes place in the reverse manner to the opening movement, i.e. from FIG. 3 via FIG. 2 to FIG. 1. In practice, the loading position is taken up from the put-away position illustrated in FIG. 3 as the user requires, for which purpose the driving device 6 is correspondingly activated.

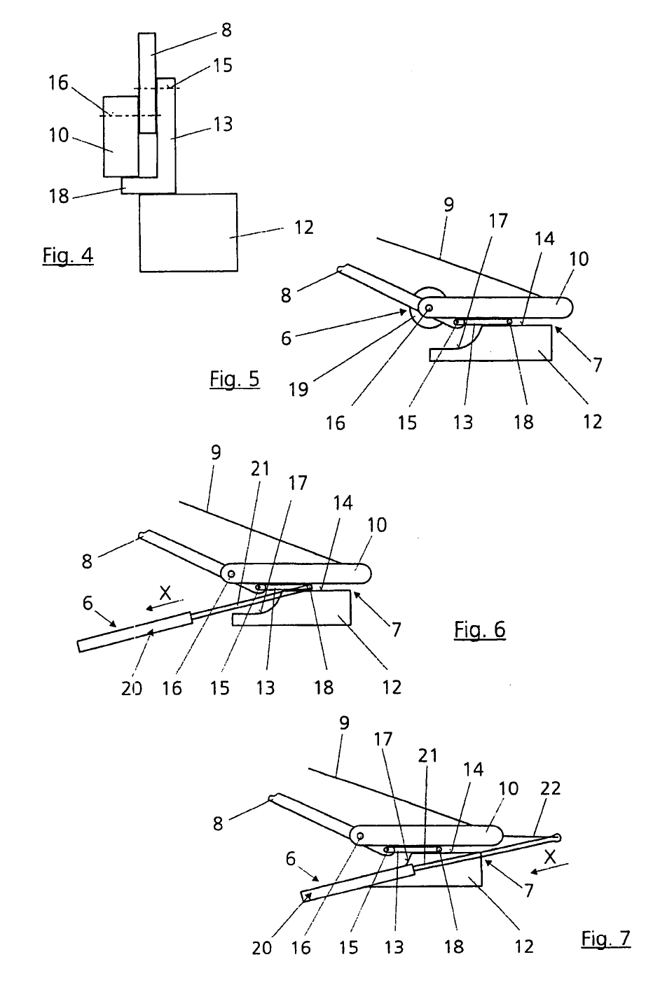

FIG. 4 illustrates, in a highly schematic manner by means of a view from the rear, how the assignment of the control lever 13 between the intermediate bearing 10 and the main bearing 12 and the attaching thereof to the main link 8 can be configured. The control lever 13 has a control bolt 18 which is arranged between the main bearing 12 and the intermediate bearing 10, moves on the control contour 14 of the main bearing 12 and ensures that the intermediate bearing 10 is guided in relation to the main bearing 12. Instead of the control bolt 18, the control lever 13 could also have a roller or a similar suitable component.

FIGS. 5, 6 and 7 show various possibilities for designing the driving device 6 for driving the hard top 1. In the embodiment illustrated in FIG. 5, the driving device 6 has rotary actuators 19 on both sides, each acting on one of the links of the top linkage 5, on the main link 8 in the present case, and of which only one is illustrated in an extremely schematic manner. The rotary actuator 19 can act on the main link 8 directly or via a gearwheel or a similar suitable device. The rotational movement caused by the rotary actuator 19 also causes the control lever 13 to move between the intermediate bearing 10 and the main bearing 12, since, as described above, it is attached to the main link 8.

In the embodiment of the driving device 6 which is illustrated in FIG. 6, a pneumatic or hydraulic cylinder-piston unit 20 is provided, acting on that end of the control lever 13 which lies opposite the pivot point 15 and thereby likewise driving the main link 8. In order to bring the hard top 1 from the closed position illustrated in FIG. 6 into the loading position or the put-away position, a piston rod 21 of the cylinder-piston unit 20, which piston rod is attached to the control lever 13, is retracted in the direction of the arrow “X”.

The cylinder-piston unit 20 is also provided in the embodiment of the driving device 6 according to FIG. 7, but its piston rod 21 acts on an extension 22 of the C-pillar link 9. In this embodiment, the main link 8 is therefore not driven, but it does, of course, likewise participate, via the upper connecting link 11, in the putting-away movement of the hard top 1. The control lever 13 which is guided between the main bearing 12 and the intermediate bearing 10 is also driven in this case via the main link 8.

All of the movements of the hard top 1 can be controlled by a control device (not illustrated) and can, if appropriate, be initiated from the interior of the convertible.

1-10. (canceled)

11. A hard top for a convertible, with at least two roof parts displaceable between a closed position and a put-away position, the roof parts, in the put-away position, being put away in a trunk of the convertible and movable into a loading position raised in relation to the put-away position, comprising:
top kinematics having at least one top linkage, at least one driving device, and at least one bearing device having a main bearing and an intermediate bearing movable in relation to the main bearing, the roof parts being coupled to the bearing device via at least one link of the top linkage and displaceable by the driving device,
a control lever attached to a link of the top linkage in an articulated manner, the control lever being arranged between the main bearing and the intermediate bearing, and
a control contour on which the control lever is guided and which is designed in such a manner that the intermediate bearing can be moved in relation to the main bearing during putting-away movement of the top only after the loading position has been reached.

12. The hard top as claimed in claim 11, wherein the control contour has a recess which makes it possible for the intermediate bearing to be lowered in relation to the main bearing.

13. The hard top as claimed in claim 11, wherein the control contour is assigned to the main bearing.

14. The hard top as claimed in claim 11, wherein the control lever has a control bolt arranged between the main bearing and the intermediate bearing.

15. The hard top as claimed in claim 11, wherein the control lever is attached to a main link of the top linkage in an articulated manner at a pivot point.

16. The hard top as claimed in claim 11, wherein the driving device has rotary actuators on both sides, and wherein each rotary actuator acts on one of the links of the top linkage.

17. The hard top as claimed in claim 11, wherein the driving device has cylinder-piston units on both sides, and wherein each cylinder-piston unit acts on the control lever or one of the links of the top linkage.

18. The hard top as claimed in claim 15, wherein the top linkage is designed as a four-bar linkage which comprises the main link, a C-pillar link, the intermediate bearing, and an upper connecting link.

19. The hard top as claimed in claim 11, wherein the at least one top linkage includes two top linkages, the at least one driving device includes two driving devices, and the at least one bearing device includes two bearing devices, and wherein the linkages, driving devices, and bearing devices are arranged on either side of the hard top.

20. A convertible with a hard top as claimed in claim 11.

21. The hard top as claimed in claim 12, wherein the control contour is assigned to the main bearing.

22. The hard top as claimed in claim 12, wherein the control lever has a control bolt arranged between the main bearing and the intermediate bearing.

23. The hard top as claimed in claim 13, wherein the control lever has a control bolt arranged between the main bearing and the intermediate bearing.

24. The hard top as claimed in claim 12, wherein the control lever is attached to a main link of the top linkage in an articulated manner at a pivot point.

25. The hard top as claimed in claim 13, wherein the control lever is attached to a main link of the top linkage in an articulated manner at a pivot point.

26. The hard top as claimed in claim 14, wherein the control lever is attached to a main link of the top linkage in an articulated manner at a pivot point.

27. The hard top as claimed in claim 12, wherein the driving device has rotary actuators on both sides, and wherein each rotary actuator acts on one of the links of the top linkage.

28. The hard top as claimed in claim 13, wherein the driving device has rotary actuators on both sides, and wherein each rotary actuator acts on one of the links of the top linkage.

29. The hard top as claimed in claim 14, wherein the driving device has rotary actuators on both sides, and wherein each rotary actuator acts on one of the links of the top linkage.

30. The hard top as claimed in claim 15, wherein the driving device has rotary actuators on both sides, and wherein each rotary actuator acts on one of the links of the top linkage.
